(19) United States
(12) Patent Application Publication
(10) Pub. No.: US 2016/0300431 A1
(43) Pub. Date: Oct. 13, 2016

(54) SYSTEM AND METHOD FOR ON-LINE FANTASY WAGERING

(71) Applicant: iPro, Inc., Incline Village, NV (US)

(72) Inventors: David ORTIZ, Newcastle, WA (US); Shanmugam CHINNASAMY, Bellevue, WA (US); Shanmugapriyan DEVARAJ, Portland, OR (US)

(21) Appl. No.: 14/684,161

(22) Filed: Apr. 10, 2015

(51) Int. Cl. G07F 17/32

(52) U.S. Cl. CPC G07F 17/3211; G07F 17/3288; G07F 17/3225

(57) ABSTRACT

Systems and methods for on-line fantasy wagering. A method includes displaying a list of available fantasy game types. The method also includes responsive to a selected type of fantasy game received by the computer, displaying a list of available sporting contests that correspond to the selected type of fantasy game. In addition, the method includes responsive to a selected available sporting contest received by the computer, displaying a graphical user interface for micro event wagering. The method further includes responsive to a selected group of offensive or defensive players received by the computer, displaying, on the display, a graphical user interface for selecting details of a micro event.

### RELATED APPLICATIONS

This application is related to co-pending, commonly owned U.S. patent application Ser. No. ______, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is related to co-pending, commonly owned U.S. patent application Ser. No. ______, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is related to co-pending, commonly owned U.S. patent application Ser. No. ______, attorney docket IPRO-0003-01.01US, filed Apr. 10, 2015, entitled “System and Method for On-line Wagering on Real Time Events” to Ortiz et al., and is hereby incorporated by reference herein in its entirety.

This application is related to co-pending, commonly owned U.S. patent application Ser. No. ______, attorney docket IPRO-0005-01.01US, filed Apr. 10, 2015, entitled “System and Method for On-Line Multi-Player Interactive Wagering” to Devaraj et al., and is hereby incorporated by reference herein in its entirety.

This application is related to co-pending, commonly owned U.S. patent application Ser. No. ______, attorney docket IPRO-0006-01.01US, filed Apr. 10, 2015, entitled “Graphical User Interface for On-Line Gaming” to Ortiz et al., and is hereby incorporated by reference herein in its entirety.

U.S. Pat. No. 8,790,176, entitled “System and Method for Real Time Interactive Entertainment” to Hopf and Ortiz, is hereby included by reference in its entirety.

### FIELD OF INVENTION

Embodiments of the present invention relate to the field of electronic applications for mobile computer systems. More specifically, embodiments of the present invention relate to systems and methods for on-line fantasy wagering.

### BACKGROUND

Wagering on sporting events, e.g., on the outcome of a sporting contest, is generally legally considered to be a game of chance. Wagering on such games of chance is generally highly restricted, and limited to a few legal jurisdictions. “Fantasy” wagering generally describes or refers to wagering based on a performance of a specific player, or a collection of specific players, over a number of wagers on a number of plays, a number of games, or a duration of game time. For example, the results of such wagers may be based on player skill more than mere chance. The cumulative effect of wagers on a number of plays and/or for a number of players may legally categorize such “fantasy” wagering as a “game of skill,” in contrast to a game of chance. Wagering on games of skill is generally more available and subject to fewer restrictions than gambling on games of chance. For example, approximately 45 U.S. States legally allow some form of fantasy gaming, while only one allows direct sports betting as a game of chance.

### SUMMARY OF THE INVENTION

Therefore, what is needed are systems and methods for on-line fantasy wagering. What is additionally needed are systems and methods for on-line fantasy wagering that enable a player to select numerous details of a wagers on micro events of at least one sporting contest. A need also exists for systems and methods for on-line fantasy wagering that utilize effective and intuitive graphical user interfaces. Further, a need exists for systems and methods for on-line fantasy wagering that are compatible and complementary with existing systems and methods of on-line and/or mobile gaming. Embodiments of the present invention provide these advantages.

In accordance with a first method embodiment of the present invention, a computer-implemented method includes displaying, on a display coupled to the computer, a list of available fantasy game types. The fantasy game types include bets on at least two micro events of at least one sporting contest. The computer-implemented method also includes responsive to a selected type of fantasy game received by the computer, displaying, on the display, a list of available sporting contests that correspond to the selected type of fantasy game. In addition, the computer-implemented method includes responsive to a selected available sporting contest received by the computer, displaying, on the display, a graphical user interface for micro event wagering. The graphical user interface for micro event wagering includes a first portion for selecting to bet on a group of offensive players to run or receive the ball and a second portion for selecting to bet on a group of defensive players to tackle a ball carrier.

The computer-implemented method further includes responsive to a selected group of offensive or defensive players received by the computer, displaying, on the display, a graphical user interface for selecting details of a micro event. The graphical user interface for placing a wager on a micro event includes a first element for selecting to bet that the micro event will be a running play, a second element for selected to bet that the micro event will be a passing play, a plurality of elements for selecting to bet on yardage to be gained on the micro event, a plurality of elements for selecting to bet on a direction of the micro event and a drive picks icon for selecting to place a recurring bet on a series of micro events during a single drive using a graphical user interface.

In accordance with another embodiment of the present invention, an article of manufacture includes a computer readable medium having instructions stored thereon that, responsive to execution by an electronic system, cause the electronic system to perform operations including displaying, on a display coupled to the electronic system, a list of available fantasy game types. The fantasy game types include bets on at least two micro events of at least one sporting contest. The operations also include responsive to a selected type of fantasy game received by the electronic system, displaying, on the display, a list of available sporting contests that correspond to the selected type of fantasy game. In addition, the operations include responsive to a selected available sporting contest received by the electronic system, displaying, on the display, a graphical user interface for micro event wagering. The graphical user interface for micro event wagering includes a first portion for selecting to bet on a group of offensive players to run or receive the ball and a second portion for selecting to bet on a group of defensive players to tackle a ball carrier.

The operations further include responsive to a selected group of offensive or defensive players received by the electronic system, displaying, on the display, a graphical user interface for selecting details of a micro event. The graphical user interface for placing a wager on a micro event includes a first element for selecting to bet that the micro event will be a running play, a second element for selected to bet that the micro event will be a passing play, a plurality of elements for selecting to bet on yardage to be gained on the micro event, a plurality of elements for selecting to bet on a direction of the micro event and a drive picks icon for selecting to place a recurring bet on a series of micro events during a single drive using a graphical user interface.

In accordance with a further embodiment of the present invention, an electronic system includes one or more processors coupled to a bus, a memory coupled to the one or more processors, wherein the memory includes a gaming application, a position determining system coupled to the bus operable to determine a geolocation of the electronic system, a graphical user interface coupled to the bus. The electronic system is configured to display, on a display coupled to the electronic system, a list of available fantasy game types, wherein the fantasy game types include bets on at least two micro events of at least one sporting contest, responsive to a selected type of fantasy game received by the electronic system, display, on the display, a list of available sporting contests that correspond to the selected type of fantasy game and responsive to a selected available sporting contest received by the electronic system, display, on the display, a graphical user interface for micro event wagering. The graphical user interface for micro event wagering includes a first portion for selecting to bet on a group of offensive players to run or receive the ball and a second portion for selecting to bet on a group of defensive players to tackle a ball carrier.

The electronic system is further configured to responsive to a selected group of offensive or defensive players received by the electronic system, display, on the display, a graphical user interface for selecting details of a micro event. The graphical user interface for placing a wager on a micro event includes a first element for selecting to bet that the micro event will be a running play, a second element for selected to bet that the micro event will be a passing play, a plurality of elements for selecting to bet on yardage to be gained on the micro event, a plurality of elements for selecting to bet on a direction of the micro event and a drive picks icon for selecting to place a recurring bet on a series of micro events during a single drive using a graphical user interface.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 illustrates an exemplary graphical user interface (GUI) for user selection from among several types of fantasy games, in accordance with embodiments of the present invention.

FIG. 3 illustrates an exemplary graphical user interface (GUI) for fantasy game creation, in accordance with embodiments of the present invention.

FIG. 4 illustrates an exemplary graphical user interface (GUI) for micro event wagering, in accordance with embodiments of the present invention.

FIG. 5 illustrates an exemplary graphical user interface (GUI) for selecting details of a micro event, in accordance with embodiments of the present invention.

FIG. 6 illustrates an exemplary graphical user interface (GUI) for placing a wager on a micro event, in accordance with embodiments of the present invention.

FIG. 7 illustrates an exemplary graphical user interface (GUI) for betting on a micro event when a duration between plays is decreased, in accordance with embodiments of the present invention.

FIG. 8 illustrates a computer-implemented method, in accordance with embodiments of the present invention.

FIG. 9 illustrates an exemplary graphical user interface (GUI) for micro event wagering, in accordance with embodiments of the present invention.

FIG. 10 illustrates an exemplary graphical user interface (GUI) for micro event wagering, in accordance with embodiments of the present invention.

FIG. 11 illustrates an exemplary graphical user interface (GUI) for micro event wagering, in accordance with embodiments of the present invention.

FIG. 12 illustrates an exemplary graphical user interface (GUI) for selecting details of micro events during a drive, in accordance with embodiments of the present invention.

FIG. 13 illustrates two exemplary graphical user interfaces for tracking details of a kick-related drive pick, in accordance with embodiments of the present invention.

FIG. 14 illustrates an exemplary graphical user interface (GUI) for selecting to wager on a running play, in accordance with embodiments of the present invention.

FIG. 15 illustrates an exemplary graphical user interface (GUI) for selecting to wager on a pass play, in accordance with embodiments of the present invention.

FIG. 16 illustrates an exemplary graphical user interface (GUI) for substituting players, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation and Nomenclature

Some portions of the detailed descriptions which follow (e.g., method 800) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “micro event” and “sub-event” are used to refer to or to describe an activity within a larger “event,” the outcome of which may be subject to a wager. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event.” For games with a less defined play structure, e.g., basketball, a fixed duration of game time, e.g., five minutes, may constitute a “micro event.” Embodiments in accordance with the present invention are well suited to wagers based on events and micro events within such events.

### System and Method for on-Line Fantasy Wagering

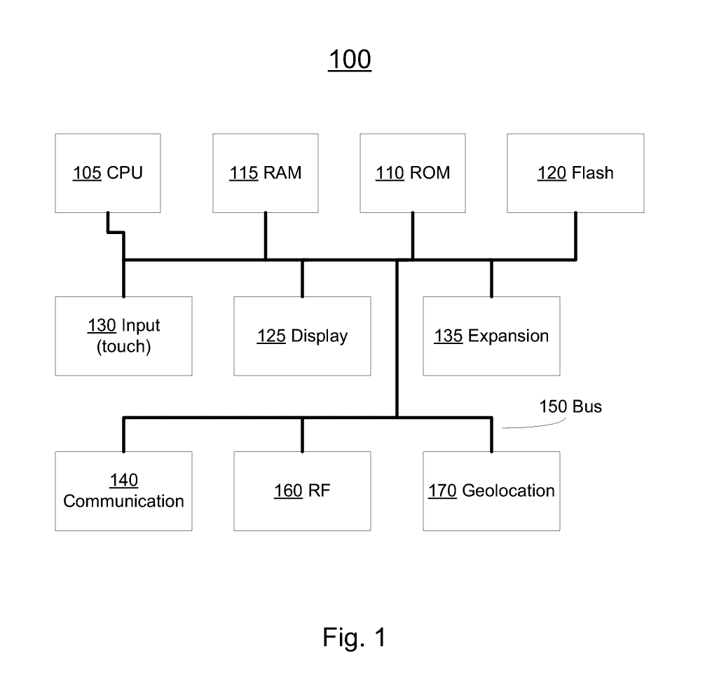

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise a portable computer system, e.g., a “smart” phone. Electronic system 100 may comprise a “wearable” computer system, e.g., a “smart” watch or an “eye-glass-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well-known devices may be attached to electronic system 100 via the bus 150 and/or expansion interface 135. Examples of such devices include without limitation rotating magnetic memory devices, flash memory devices, digital cameras, wireless communication modules, digital audio players, and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

In accordance with embodiments of the present invention, a gaming application program running on an embodiment of electronic system 100 automatically determines the device's geolocation. While embodiments in accordance with the present invention are generally disclosed using examples of portable computer systems, e.g., “smart phones,” a device's geolocation should be determined even if the electronic system is of a type not generally considered to be portable, e.g., a “desk top” computer system, in accordance with embodiments of the present invention. Based on the geolocation, the device automatically and transparently to the user switches among at least two different types of games. For example, the types of games may include real money gambling, social points gambling, and/or fantasy gambling. Co-pending, commonly owned U.S. patent application Ser. No. 13/______, attorney docket IPRO-0001-01.01US, filed Apr. 10, 2015, entitled “Method and System for Seamless Transitions between Game Types for Portable Computer Systems” to Devaraj et al., included by reference herein in its entirety, discloses further information on determining a legal jurisdiction for wagering.

When the electronic system 100 is located within a jurisdiction that does not allow gambling, only non-gambling types of games, e.g., games for social points, are made available to the user. When the electronic system 100 is located within a jurisdiction that does allow gambling, then real money gambling is made available to the user. It is appreciated that not all jurisdictions that allow some types of gambling allow all types of gambling. For example, some jurisdictions allow “real money” wagering on “games of skill,” e.g., “fantasy sports,” while prohibiting “real money” wagering on “games of chance,” e.g., singular outcomes. Accordingly, embodiments in accordance with the present invention may provide further granularity as to types of games. For example, based on the laws of a particular jurisdiction, a device may switch among more than one type of real money gambling, e.g., based on a type of wager, in addition to social points gaming.

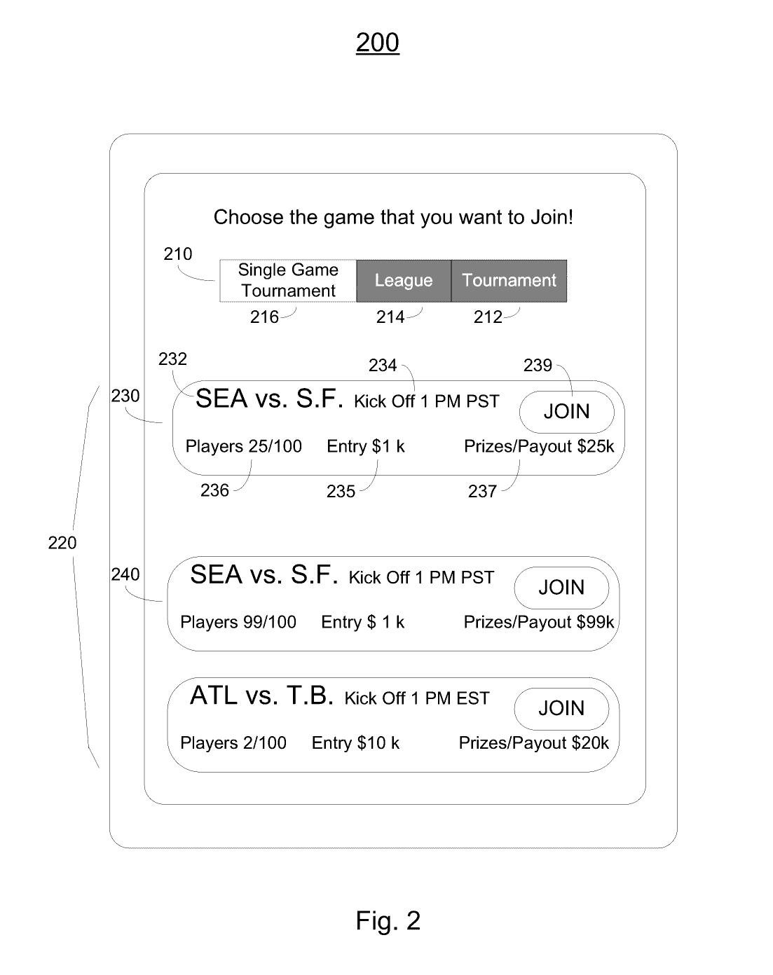

Responsive to a determination that fantasy gaming is legally allowed in a user's jurisdiction, a user may be presented an opportunity to select among one or more types of fantasy games. FIG. 2 illustrates an exemplary graphical user interface (GUI) 200 for user selection from among several types of fantasy games, in accordance with embodiments of the present invention. Graphical user interface 200 may be displayed, for example, on display unit 125 of electronic system 100, as illustrated in FIG. 1. User input to the electronic system 100 may be accepted from a touch sensitive digitizer panel, e.g., touch sensitive digitizer panel 130 of FIG. 1, a coupled keyboard, stylus, trackball, voice recognition, eye tracking, spatial gesture recognition, or any other suitable input device.

Fantasy games, in general, have s set entry fee, e.g., as displayed in element 235 of FIG. 2, and a set prize pool, e.g., as displayed in element 237 of FIG. 2. Payouts do not fluctuate based on a number of entrants. For example, a tournament will not be started unless the full number of players enters the tournament and/or game session.

Element 210 of graphical user interface 200 illustrates an exemplary fantasy game type display and selection mechanism. For example, types of fantasy games may include a “tournament” fantasy game 212, a “league” fantasy game 214 and/or a “single game tournament” fantasy game 216, in accordance with embodiment of the present invention. A “single game tournament” fantasy game may be a contest among a group of players involving wagers on a plurality of micro events of a single sporting contest. Activation of one of the fantasy game type selections 212, 214, or 216, e.g., via touch or “clicking,” highlights that fantasy game type. For example, FIG. 2 illustrates that the fantasy game type selection “Single Game Tournament” 216 has been selected, as the “Single Game Tournament” 216 button is presented in dark text on a light background, while the other buttons are presented with light text on a dark background.

A fantasy game may be understood as comprising two levels of wagering. A high-level wager is a bet that a player will win money, e.g., the “pool,” based on one's “skill” in predicting the course of one or more sporting events. Such “skill” is demonstrated via a series of low-level wagers. Low-level wagers comprise bets on micro events within the sporting event(s). Players participating in a fantasy game may make wagers on micro events that may win (or loose) “fantasy” points. Each player accumulates fantasy points based on wagers on a plurality of micro events. In accordance with embodiments of the present invention, each micro event may have an associated likely hood factor. A winner of a fantasy game, e.g., a winner of the “high-level” wager, is determined as the player with the most fantasy points from among all participants in a fantasy game. Accordingly, a monetary payout is based indirectly on numerous micro-event wagers. It is to be appreciated that payouts may be awarded to more than a single player. Exemplary payout structures may include winner takes all, the top 30% of players receive some payout, and/or the top 50% of players receive a payout.

For example, a micro event may correspond to a “play” in a football game. An exemplary wager on such a micro event may be that the running back, number 42, takes a handoff and runs to the offense's right, gaining between 3 and 9 yards. Since the probability of such a specific play and outcome may be rather low, the wager may include a likelihood “incentive” or “factor” to encourage or incentivize a player to make such a wager. Accordingly, in general, a fantasy game is influenced by a player's skill in wagering, in consideration of such likelihood factors, in addition to the player's skill in predicting a course of a sporting contest, over numerous micro events.

A “single game tournament” type of fantasy game may comprise more than one player making a series of wagers on micro events within a single sporting contest, e.g., a professional football game between Seattle and San Francisco. Typically, a minimum number of wagers on micro events is required. The minimum number may be determined to ensure that legal authorities of the jurisdiction(s) consider the game to be one of “skill,” as opposed to “luck,” and thus to legally qualify as a “fantasy” game. Typically, a player is not required to bet on all micro events of the sporting contest(s), but must wager on at least the specified minimum number of micro events.

A “tournament” type of fantasy game may comprise more than one player making a series of wagers on micro events within a group of more than one sporting contest. For example, the tournament may include all football games on a given Sunday, all football games with approximately the same start time, or all football games for a given week, e.g., week 14 of the football league's season. Typically, a minimum number of wagers on micro events is required. The winner of the tournament is the player who accumulates the most fantasy points over the span of the tournament. It is appreciated that the ultimate winner may not “win,” e.g., accumulate the most fantasy points, for every individual sporting contest, or even accumulate the most fantasy points for any sporting contests, within the tournament.

A “tournament” may comprise at least three arrangements of multiple games. For example, two games of a tournament may be “back to back,” e.g., there is no overlap among the games. Two games of a tournament may overlap, e.g., both games, or significant portions of both games, may occur at the same time. Two games of a tournament may also occur over two or more different days.

A “league” type of fantasy game may comprise a large number of sporting contests over a greater duration than a “tournament,” for example, all regular season contests for a particular team, or all regular season contests for all teams. As with the other types of fantasy games, each player makes a minimum number of wagers on micro-events. A player may not be required to make a wager on a micro event in every game of the league span. For example, if the league fantasy game spans 16 games, a player may make at least the minimum number of wagers in fewer, e.g., eight, games. The winner of the fantasy league is the player who accumulates the most fantasy points over the span of the league. It is appreciated that the ultimate winner may not “win,” e.g., accumulate the most fantasy points, for every individual sporting contest, or even accumulate the most fantasy points for any sporting contests, within the league.

Element 220 of graphical user interface 200 illustrates an exemplary game selection mechanism, in accordance with embodiments of the present invention. Game selection list 220 comprises a list of available fantasy games corresponding to the fantasy game type selected in element 210. If the list 220 is greater than available display space, the list of available fantasy games 220 may be scrolled and/or paged in any suitable manner. Listing and/or ordering of available fantasy games may be based on geographic location, in some embodiments. For example, a user in a particular geographic area may be more interested in gambling on a local team. Listing and/or ordering of available fantasy games may also be based on a user's history, in some embodiments.

Element 230 of graphical user interface 200 illustrates an exemplary fantasy game listing, in accordance with embodiments of the present invention. Game listing 230 comprises a game identification display 232, e.g., “SEA vs. S.F.,” and a game start time display 234, e.g., “kick off 1 PM PST.” It is to be appreciated that the game start time display 234 may indicate and/or confirm a type of sporting contest. For example, those in North America would recognize the term “kick off” as referring to football, while “first pitch” would be recognized as referring to baseball, “tip off” would be recognized as referring to basketball, and “puck drop” would be recognized as referring to hockey. Game start time display 234 may also indicate a last time for joining in a particular fantasy game.

Game listing 230 also comprises a number of players/limit of players display 236. Number of players/limit of players display 236 displays a number of players participating, or waiting to participate, in the specific fantasy game. Number of players/limit of players display 236 also indicates a maximum number of players allowed to join the particular fantasy game, as the second number after and to the right of the forward slash “/” of the display. In addition, game listing 230 comprises an entry fee display 235. Entry fee display 235 indicates the entry fee required of a player to join the particular fantasy game. Game listing 230 further comprises a prizes/payout display 237. Prizes/payout display 237 indicates what a winner of the fantasy game may receive. Prizes/payout display 237 may display a calculation of a payout based upon a current number of players in some embodiments. In some embodiments, prizes/payout display 237 may display a largest or maximum payout based on a maximum limit of players. Prizes/payout display 237 may display a largest of several payouts for games with more than a single payout, in some embodiments.

Many entries of the list of available fantasy games 220 may be similar or the same. For example, game listing 240 is for the same game, e.g., Seattle vs. San Francisco, as game listing 230. However, game listing 240 indicates that the game has nearly reached its player limit, e.g., there are currently 99 player out of a maximum of 100 players. A player may favor joining the fantasy game associated with game listing 240, as the potential payout is larger, for example. However, a player may favor joining the fantasy game associated with game listing 230, as the likelihood of winning may be greater given fewer players. There may be other differences between two game listings, including, for example, the participants in the fantasy game, which may influence a player's choice among similar game listings.

Game listing 230 comprises a join button 239. A user touches or otherwise selects join button 239 to indicate that the user wishes to participate in the particular fantasy game 230.

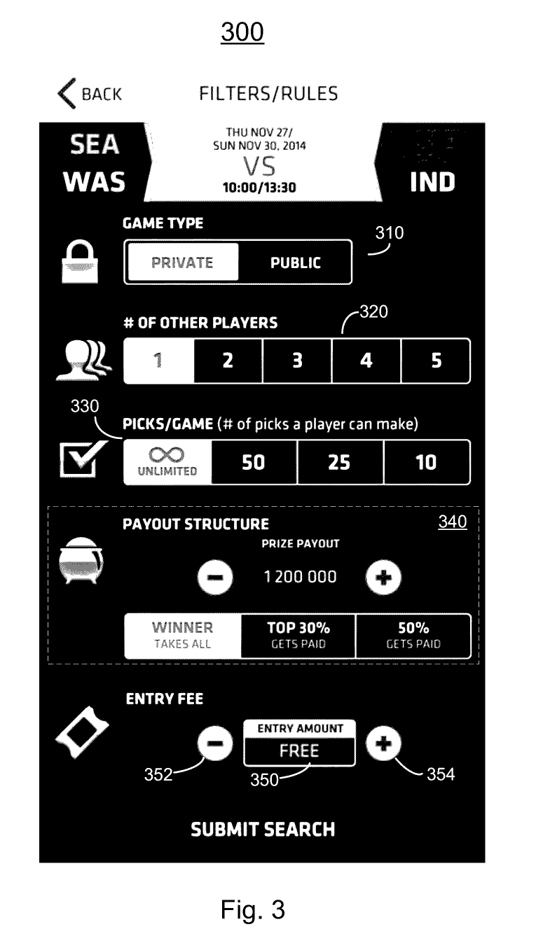

In accordance with embodiments of the present invention, a player may create or initiate a fantasy game. FIG. 3 illustrates an exemplary graphical user interface (GUI) 300 for fantasy game creation, in accordance with embodiments of the present invention. A player may create or initiate a fantasy game using graphical user interface 300 for display in a fantasy game listing, for example fantasy game listing 220 of FIG. 2.

Fantasy game creation graphical user interface 300 comprises a public/private button set 310. Public/private button set 310 allow a user, e.g., via touch input, to select whether a fantasy game is to be public or private. For example, a public fantasy game is viewable and bet-able by all users of a gaming system, whereas a private fantasy game is limited to selected users. In the example of FIG. 3, the fantasy game is private.

Graphical user interface 300 also comprises a number of participants button set 320. Number of participants button set 320 enables a fantasy-game initiator to select a number of participants in a fantasy game. For example, the fantasy-game initiator is willing to challenge from one to five other players. Number of participants button set 320 may scroll or page to display and allow selection of other numbers of participants, in accordance with embodiments of the present invention. In the example of FIG. 3, the creator of the fantasy game is willing to compete with one other player.

Graphical user interface 300 comprises a picks per game button set 330. Picks per game button set 330 enables a fantasy-game initiator to select a number of wagers on micro events in a fantasy game. In the example of FIG. 3, a fantasy game may include wagers on 10, 25, 50, or an unlimited number of micro events. It is appreciated that other numbers of required wagers are well suited to embodiments in accordance with the present invention. In the example of FIG. 3, the creator of the fantasy game is willing to accept unlimited numbers of micro event wagers. In addition, graphical user interface 300 comprises a payout structure button set 340. Payout structure button set 340 allows a fantasy-game initiator to select from among a set of payout structures to reward achievement in a fantasy game. In the example of FIG. 3, a fantasy-game initiator may select from among a winner takes all payout structure, a payout structure in which players ranking in the top 30% (by points score) receive a payout, and a payout structure in which players ranking in the top 50% (by points score) receive a payout. In the example of FIG. 3, a “winner takes all” payout structure has been selected.

Graphical user interface 300 also comprises a fantasy game entry fee selection field 350. Fantasy game entry fee selection field 350 allows a fantasy-game creator to specify an entry fee amount for a fantasy game. For example, an entry fee amount may be increased by touching plus button 4354, and decreased by touching minus button 352. Fantasy game entry fee selection field 350 may also operate as a slider, e.g., moving a finger touching within wager amount field 350, toward plus button 354 increases an entry fee amount, while moving a finger toward minus button 352 decreases an entry fee amount.

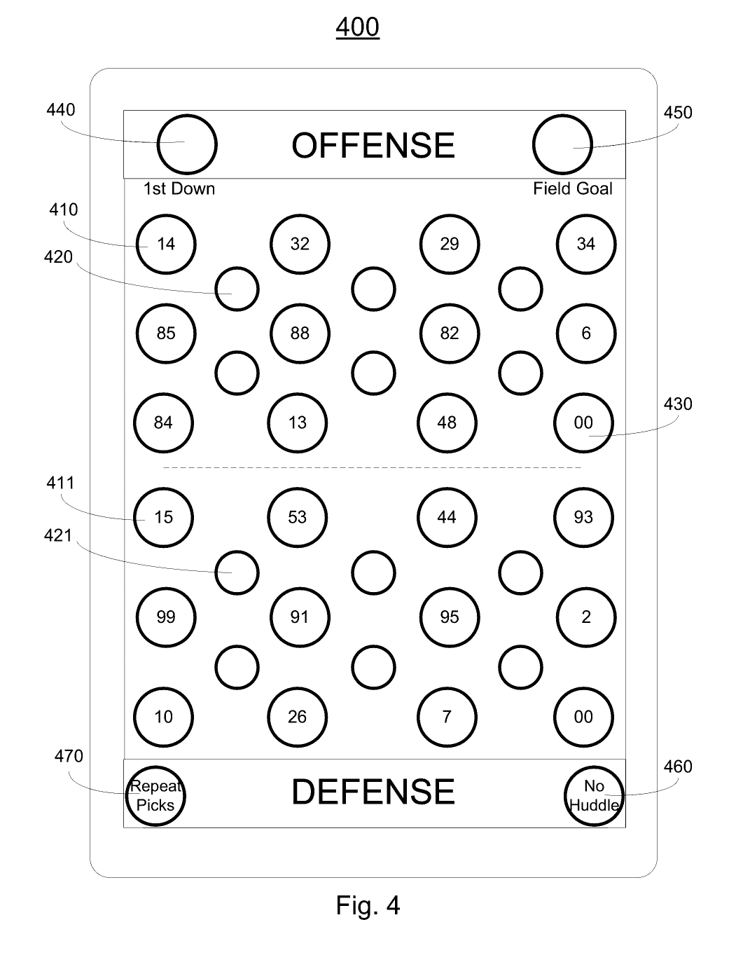

FIG. 4 illustrates an exemplary graphical user interface (GUI) 400 for micro event wagering, in accordance with embodiments of the present invention. In the exemplary embodiment of FIG. 4, the display 400 is configured for wagering on micro events in a football contest. Approximately the top half of display 400 is for initiation of wagers on micro events related to the offensive team, while approximately the bottom half of display 400 is for initiation of wagers on micro events related to the defensive team. Display 400 comprises a plurality of player icons, e.g., player icon 410, comprising a circle outlining a number. Each player icon represents the player with that number that plays at approximately that position. For example, the number 14 may generally correspond to a quarterback, punter, or place kicker. Selecting a player icon, e.g., by touching the icon, will initiate a different display to select specific details of an upcoming play, e.g., a micro event, involving the player indicted by the player icon. Player icons, e.g., player icon 411, are presented for defensive players, as well. An example wager on a defensive micro event may be on which player will tackle a ball carrier, or on which player will intercept a pass.

Display 400 also comprises a plurality of player group icons, e.g., player group icon 420. A player group icon comprises a circle without a number. A player group icon represents a group of four players in closest proximity to the player group icon. For example, player group icon 420 represents players 14, 32, 85 and 88. Selecting a player group icon, e.g., by touching the icon, will initiate a different display to select specific details of an upcoming play, e.g., a micro event, involving one or more of the players indicted by the player group icon. Player group icons, e.g., player group icon 421, are presented for groups of defensive players, as well.

Player icon 430, referring to player “00,” is a special case. Player icon 430 refers to an offensive player other than the players indicated in the other offensive player icons. For example, the numbers in the player icons may refer to the players that start a game. In many sporting contests, including football, players may substitute, sometimes on a play-by-play basis. Accordingly, player icon 430 represents any player, possibly a substitute player, that is not represented by another player icon, e.g., has a different number than a displayed player icon. Player “00” is known as or referred to as a “wild card.”

Display 400 comprises a plurality of team result icons, e.g., 1st down icon 440 and field goal icon 450. Team result icons represent play results, e.g., micro events, which are more generalized than the play results associated with player icons and/or player group icons. For example, 1st down icon 440 represents that the offensive team will achieve a first down by any type of play featuring any player(s). Similarly, field goal icon 450 represents that the offensive team will score a field goal.

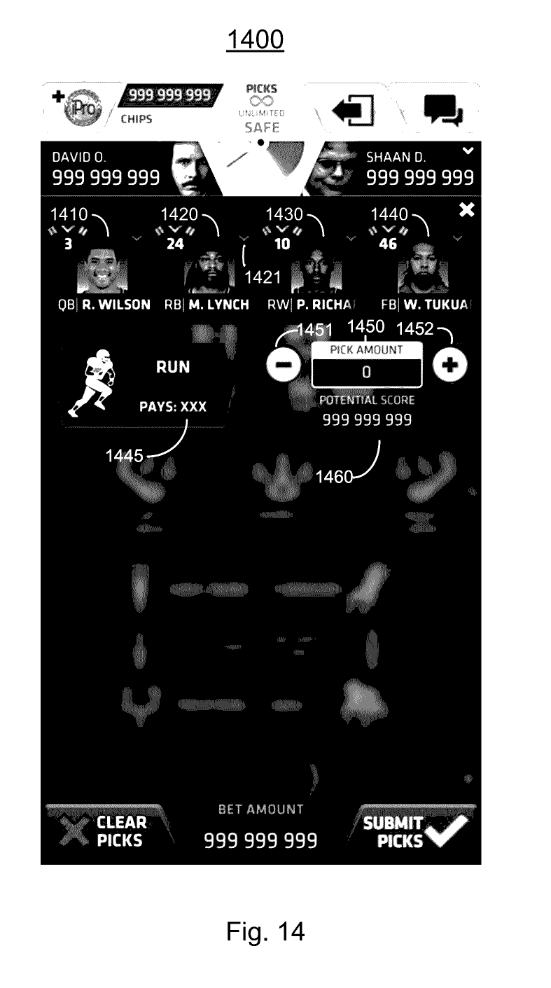

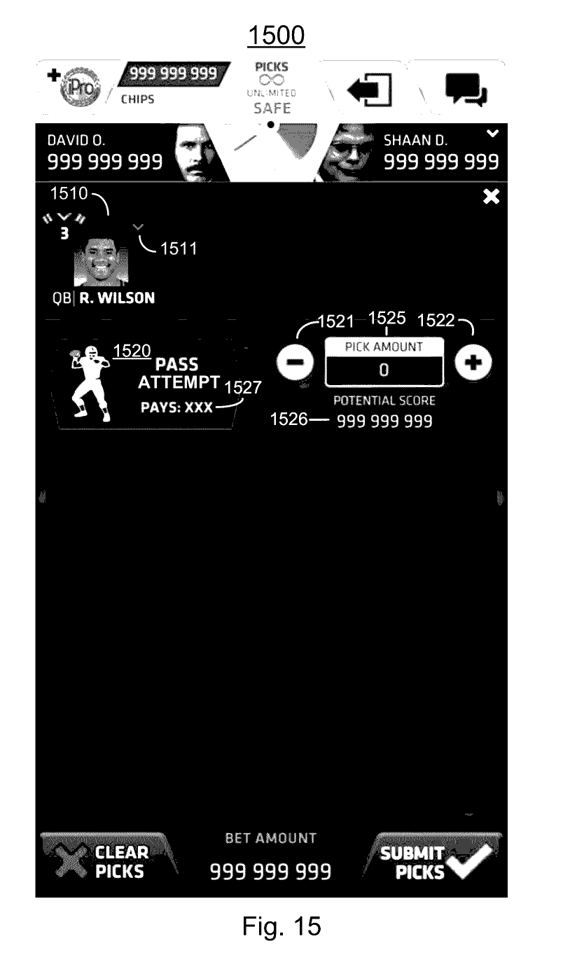

Some legal jurisdictions do not allow real money fantasy wagers on a team basis. For example, such wagers must involve a specific player. In such cases, a user will be presented with additional graphical user interfaces, as described below in FIGS. 14, 15 and/or 16, that enable specific and/or group player selection(s) responsive to selecting a team play selection, e.g., run or pass.

Display 400 also comprises a repeat picks icon 470. Repeat picks icon 470 may be used to repeat the wager on a play, e.g., a micro event, that was selected for the immediately preceding play. Display 400 further comprises a no huddle icon 460. No huddle icon 460 initiates a different version of a graphical user interface for use when a duration between plays is decreased, for example, when a fantasy player might not have enough time to select details of a micro event according to graphical user interface 400, e.g., when the offense is playing a “no huddle” style of play.

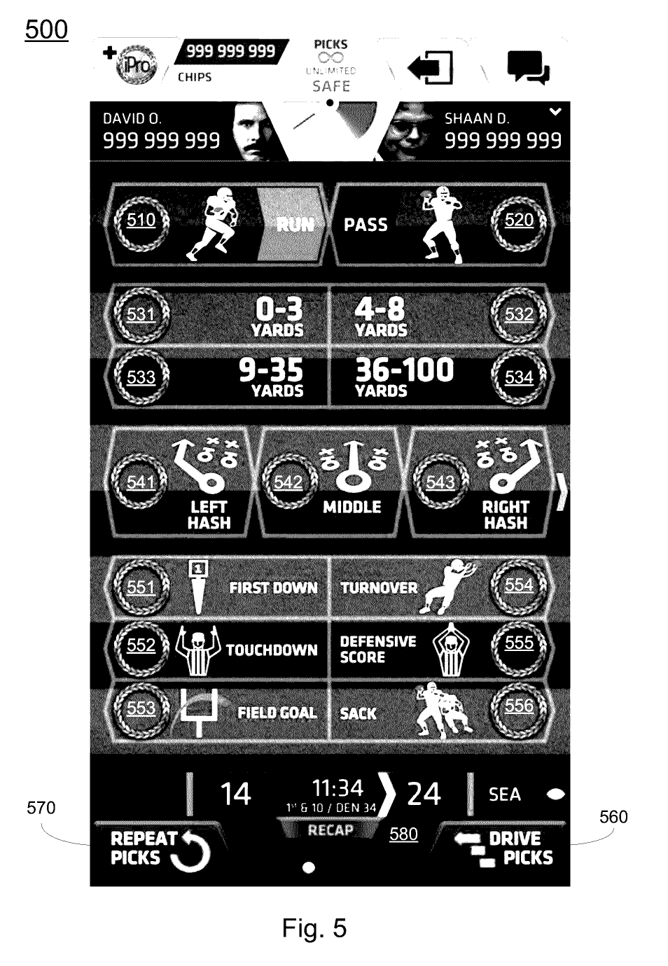

FIG. 5 illustrates an exemplary graphical user interface (GUI) 500 for selecting details of a micro event, in accordance with embodiments of the present invention. Graphical user interface 500 may be presented, for example, responsive to indicating a player icon 410 or a player group icon 420 of FIG. 4. Graphical user interface 500 enables a player to specify a prediction of the results of a next play, e.g., a next micro event. A player may predict a running play via run icon 510, or may predict a passing play via pass icon 520. A player may predict how many yards a play will gain, e.g., via 0-3 yards icon 531, 4-8 yards icon 532, 8-36 yards icon 533 and 36-100 yards icon 534. A player may also predict a direction of an upcoming play, e.g., left hash icon 541, middle icon 542 or right hash icon 543.

Graphical user interface 500 comprises a group of “game event” icons 551, 552, 553, 554, 555 and 556. Game event icons 551, 552 and 553 are generally associated with offensive team achievements, while game event icons 554, 555 and 556 are generally associated with defensive team achievements. Game event icons are used to predict offensive and/or defensive team achievements, in accordance with embodiments of the present invention. Game event icons are not exclusive of the other icons 510 through 534. For example, in a first scenario, a user may select only game event first down icon 551, indicating a prediction that the offense will achieve a first down, by any means. In a second scenario, a user may select game event first down icon 551 and run icon 510, indicating a prediction that that the offense will achieve a first down by running the ball. The latter prediction comprising a run for a first down is more specific that the former prediction of a first down by any means, and may have a greater likelihood factor, or odds, and a potentially larger payout for an equivalent wager. All such combinations that are consistent with the rules and structure of the current sporting event may be allowed. Some combinations, e.g., an offensive first down 551 coupled with a defensive sack 556 may not be allowed.

Game event first down icon 551 is used to enter a user prediction that a next play, e.g., a micro event, will result in a first down for the offense. Game event touch down icon 552 is used to enter a user prediction that a next play, e.g., a micro event, will result in a touch down for the offense. Game event field goal icon 553 is used to enter a user prediction that a next play, e.g., a micro event, will result in a field goal for the offense.

Game event turnover icon 554 is used to enter a user prediction that a next play, e.g., a micro event, will result in a turnover for the defense, e.g., the offense looses the ball. Game event defensive score icon 555 is used to enter a user prediction that a next play, e.g., a micro event, will result in a score, e.g., a safety or a touchdown, for the defense. Game event sack icon 556 is used to enter a user prediction that a next play, e.g., a micro event, will result in a sack for the defense.

Graphical user interface 500 also comprises a repeat picks icon 570, similar to repeat picks icon 470 of FIG. 4, and a drive picks icon 560. Drive picks icon 560 may be used to indicate or select that a user desires to make the same or similar picks for the duration of a “drive.” In general, the picks made within a drive picks graphical user interface(s) will last until the ball changes possession. In general, a user will be able to initiate a “drive picks” mode of game play during fourth down, punt return and/or kick-off return scenarios. In some embodiments, a user may be limited to initiation of drive picks to only such scenarios.

Graphical user interface 500 further comprises a scoreboard display 580 that presents a variety of information related to the sporting contest.

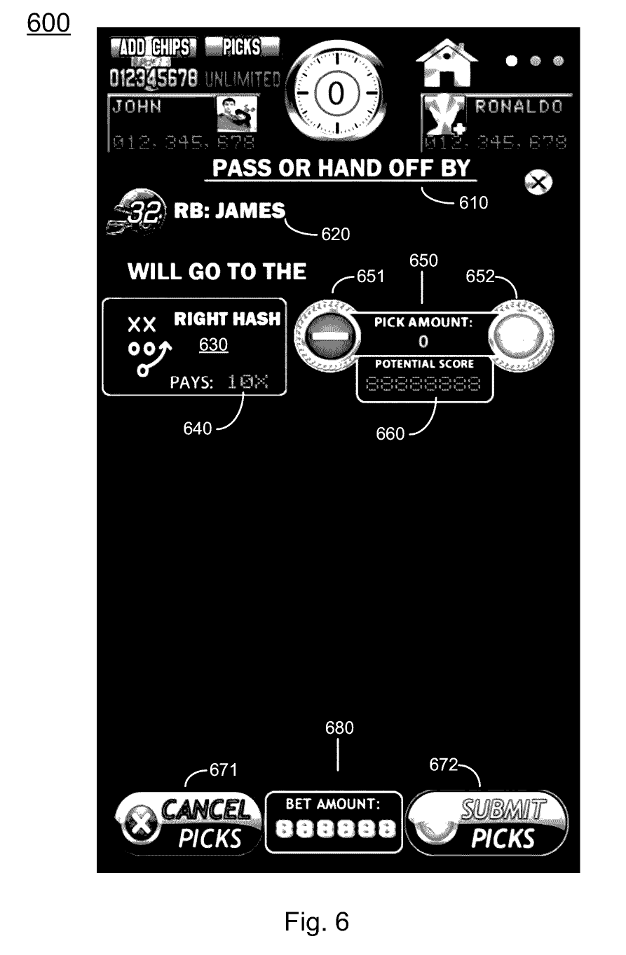

FIG. 6 illustrates an exemplary graphical user interface (GUI) 600 for placing a wager on a micro event, in accordance with embodiments of the present invention. Graphical user interface 600 may be presented, for example, responsive to indicating a variety of predictions for a next play, e.g., micro event, of a sporting contest, for example via graphical user interface 500 of FIG. 5. Graphical user interface 600 comprises a summary play type display 610. In general, summary play type display 610 reflects a play type prediction, for example, a running play or a passing play, identified by selecting run icon 510 or pass icon 520 from graphical user interface 500 of FIG. 5. In the example of FIG. 6, neither run nor pass was predicted. Graphical user interface 600 comprises a summary player display 620. In general, summary player display 620 reflects a player identified by selecting a player icon from graphical user interface 400 of FIG. 4. In the example of FIG. 6, a running back named James wearing number 32 was selected.

Graphical user interface 600 also comprises a play direction summary display 630. In general, summary play direction display 630 reflects a play direction prediction, for example, to the right hash, identified by selecting a play direction icon, e.g., right hash icon 543, from graphical user interface 500 of FIG. 5.

Graphical user interface 600 comprises a likelihood factor display 640. Likelihood factor display 640 displays a multiplication factor of a wager on a micro event. The likelihood factor is inversely correlated with a probability of the particular play, e.g., micro event, happening. In the example of FIG. 6, the micro wager pays ten times the points wagered if the upcoming micro event occurs as predicted by the player. Graphical user interface 600 further comprises a pick amount field 650. Pick amount field 650 allows a user to change an amount of the bet. For example, a pick amount may be increased by touching plus button 652, and decreased by touching minus button 651. Pick amount field 650 may also operate as a slider, e.g., moving a finger touching within pick amount field 650, toward plus button 652 increases a wager amount, while moving a finger toward minus button 651 decreases a pick amount.

In addition, graphical user interface 600 comprises a potential score display 660. Potential score display 660 indicates a number of fantasy points that may be won if the upcoming micro event occurs as predicted by the player. Potential score display 660 reflects the pick amount displayed in pick amount field 650 multiplied by the likelihood factor displayed in likelihood factor display 640.

Graphical user interface 600 further comprises a cancel button 671, a submit button 672 and a “bet amount” field 680. Bet amount field 680 displays the total amount, in fantasy points, a user will bet, e.g., be at risk, if the bet is created and accepted by the maximum allowed users. Touching or otherwise indicating cancel button 671 terminates the current creation of a bet. Touching or otherwise indicating submit button 672 causes the bet to be created. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

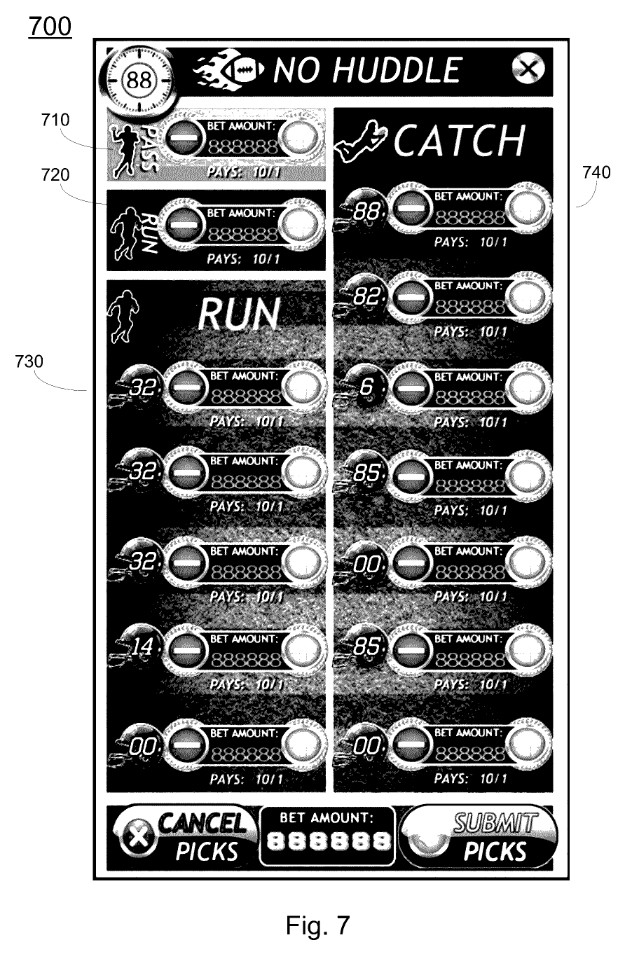

FIG. 7 illustrates an exemplary graphical user interface (GUI) for betting on a micro event when a duration between plays is decreased, e.g., in a “no huddle” situation, in accordance with embodiments of the present invention. Graphical user interface 700 comprises a team pass bet amount element 710. Team pass bet amount element 710 is used to place a wager amount that the next micro event will be any pass play, to any player. The pass may be a complete pass, or any pass result, including, for example, complete, incomplete or intercepted passes, in some embodiments. Team pass bet amount element 710 displays a likelihood factor for the wager, and allows a player to select a bet amount, via a mechanism similar to pick amount field 650 of FIG. 6.

Similarly to team pass bet amount element 710, graphical user interface 700 comprises a team run bet amount element 720. Team run bet amount element 720 is used to place a wager amount that the next micro event will be any running play, to any player. Graphical user interface 700 comprises a plurality of player run bet amount elements, e.g., player run bet amount element 730. Player run bet amount elements are used to play a wager amount that a specific player will run the ball on the next micro event. For example, selection of player run bet amount element 730 represents a wager that player number 32 will run the ball. There may be player run bet amount elements for all players that typically run the ball, as well as a special player run bet amount element for player “00,” representing any player without a specific player run bet amount element.

Graphical user interface 700 comprises a plurality of player pass bet amount elements, e.g., player pass bet amount element 740. Player pass bet amount elements are used to play a wager amount that a specific player will catch the ball on the next micro event. For example, selection of player pass bet amount element 740 represents a wager that player number 88 will catch the ball. There may be player pass bet amount elements for all players that typically may receive passes, e.g., eligible receivers, as well as a special player pass bet amount element for player “00,” representing any player without a specific player pass bet amount element.

Graphical user interface 700 also comprises a cancel button, a submit button, and a “bet amount” field, with similar appearance, placement and functionality as described with respect to cancel button 671, submit button 672, and “bet amount” field 680 of FIG. 6.

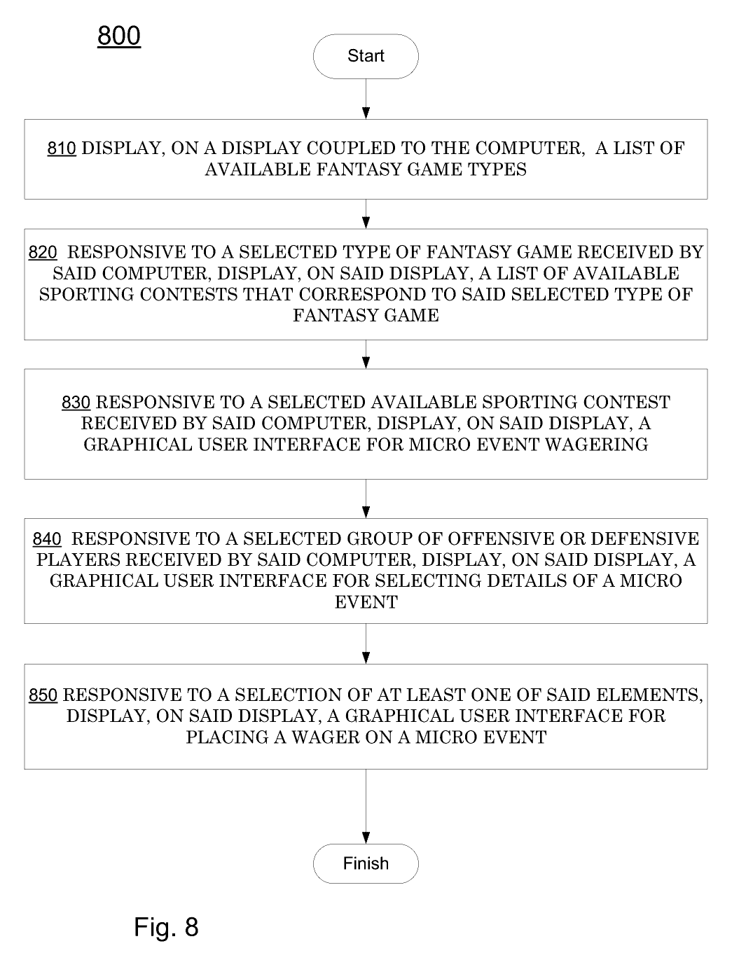

FIG. 8 illustrates a computer-implemented method 800, in accordance with embodiments of the present invention. In 810, a list of available fantasy game types is displayed on a display coupled to the computer. The fantasy game types include bets on at least two micro events of at least one sporting contest. For example, the at least two micro events may occur in a single sporting contest, or a first micro event may occur in a first sporting contest and a second micro event may occur in a second sporting contest. In 820, responsive to a selected type of fantasy game received by the computer, a list of available sporting contests that correspond to the selected type of fantasy game is displayed on the display.

In 830, responsive to a selected available sporting contest received by the computer, a graphical user interface for micro event wagering is displayed on the display. The graphical user interface for micro event wagering includes a first portion for selecting to bet on a group of offensive players to run or receive the ball and a second portion for selecting to bet on a group of defensive players to tackle a ball carrier. The groups of players may be a single player, for example. In 840, responsive to a selected group of offensive or defensive players received by the computer, a graphical user interface for selecting details of a micro event is displayed on the display. The graphical user interface for placing a wager on a micro event includes a first element for selecting to bet that the micro event will be a running play, a second element for selected to bet that the micro event will be a passing play, a plurality of elements for selecting to bet on yardage to be gained on the micro event, a plurality of elements for selecting to bet on a direction of the micro event and a drive picks icon for selecting to place a recurring bet on a series of micro events during a single drive.

In optional 850, responsive to a selection of at least one of the elements, a graphical user interface for placing a wager on a micro event is displayed on the display. The a graphical user interface for placing a wager on a micro event includes a display of a type of play selected, a display of a player selected, a display of a direction of a play selected, a display of a payout factor for a micro event wager and an element to display and adjust a bet amount for the micro event wager.

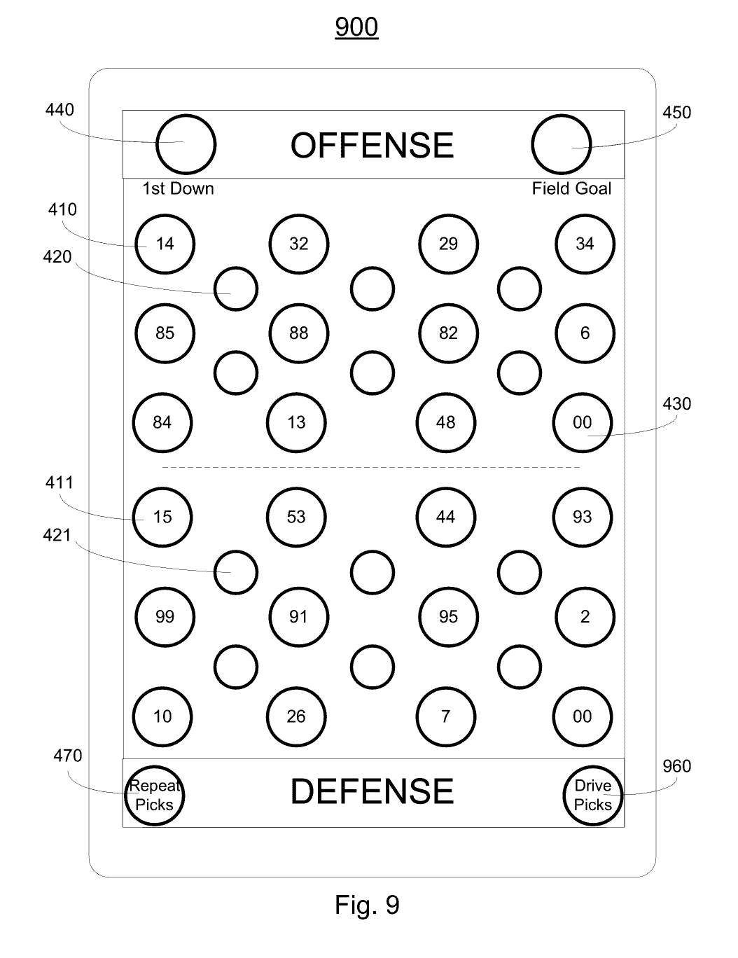

FIG. 9 illustrates an exemplary graphical user interface (GUI) 900 for micro event wagering, in accordance with embodiments of the present invention. Graphical user interface 900 is substantially similar to graphical user interface 400 of FIG. 4. A difference between graphical user interfaces 400 and 900 is that the no huddle icon 460 of FIG. 4 is replaced by a “drive picks” icon 960 in FIG. 9.

Activation of the “drive picks” icon 960 initiates a different version of a graphical user interface for use when a user desires to make the same or similar picks for the duration of a “drive.” In general, the picks made within the drive picks graphical user interface(s) will last until the ball changes possession. In general, a user will be able to initiate a “drive picks” mode of game play during fourth down, punt return and/or kick-off return scenarios. In some embodiments, a user may be limited to initiation of drive picks to only such scenarios.

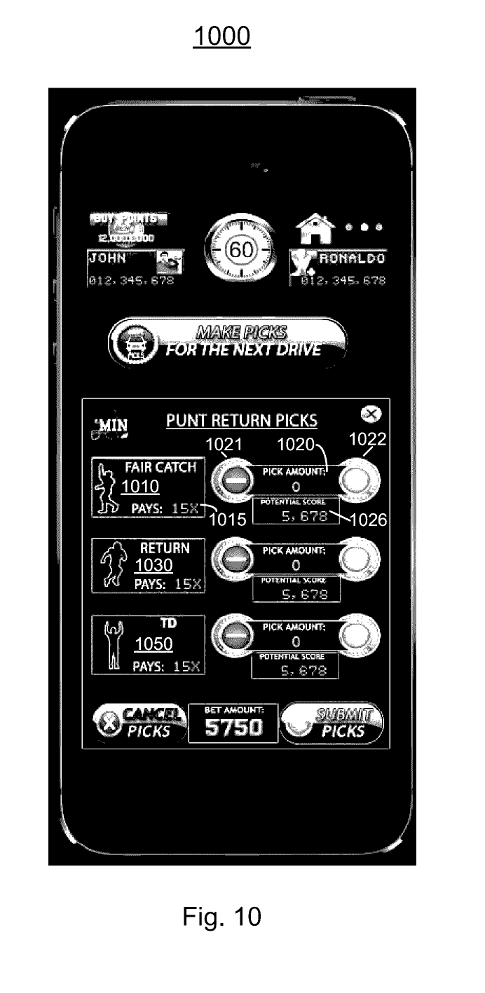

FIG. 10 illustrates an exemplary graphical user interface (GUI) 1000 for micro event wagering, in accordance with embodiments of the present invention. Graphical user interface 1000 may be displayed responsive to a user selection of a “drive picks” icon 960 in FIG. 9, in conjunction with a game situation of an impending punt and subsequent punt return opportunity.

Graphical user interface 1000 comprises a fair catch icon 1010. Selection of fair catch icon 1010 indicates a user wager that the result of the upcoming punt will be a fair catch. Fair catch icon 1010 comprises a likelihood factor display 1015. Likelihood factor display 1040 displays a multiplication factor of a wager on a micro event. The likelihood factor is inversely correlated with a probability of the particular play, e.g., micro event, happening. In the example of FIG. 10, the micro wager pays 15 times the points (or real money) wagered if the upcoming micro event, e.g., a fair catch, occurs as predicted by the player.

Graphical user interface 1000 further comprises a pick amount field 1020 for fair catch icon 1010. Pick amount field 1020 allows a user to change an amount of the bet, e.g., that the result of a punt will be a fair catch. For example, a pick amount may be increased by touching plus button 1022, and decreased by touching minus button 1021. Pick amount field 1020 may also operate as a slider, e.g., moving a finger touching within pick amount field 1020, toward plus button 1022 increases a wager amount, while moving a finger toward minus button 1021 decreases a pick amount.

In addition, graphical user interface 1000 comprises a potential score display 1026. Potential score display 1026 indicates a number of fantasy points, or real currency, depending on the game type, that may be won if the upcoming micro event occurs as predicted by the player. Potential score display 1026 reflects the pick amount displayed in pick amount field 1020 multiplied by the likelihood factor displayed in likelihood factor display 1015.

In addition, graphical user interface 1000 comprises return icon 1030, for wagering that the result of a punt will be a return. Associated with return icon 1030 are pick amount buttons, a pick amount display, a likelihood factor display and a potential score display, which operate in a similar manner to those functions and displays associated with fair catch icon 1010.

Further, graphical user interface 1000 comprises touchdown (TD) icon 1050, for wagering that the result of a punt will be a touchdown. Associated with return icon 1026 are pick amount buttons, a pick amount display, a likelihood factor display and a potential score display, which operate in a similar manner to those functions and displays associated with fair catch icon 1010.

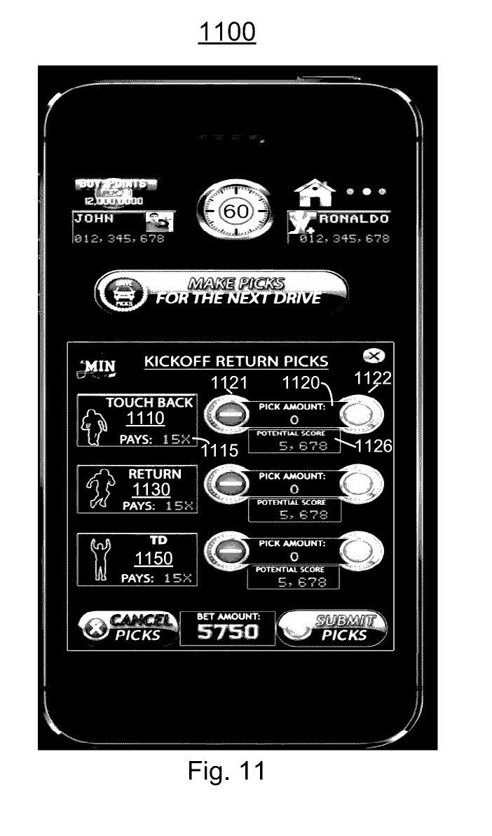

FIG. 11 illustrates an exemplary graphical user interface (GUI) 1100 for micro event wagering, in accordance with embodiments of the present invention. Graphical user interface 1100 may be displayed responsive to a user selection of a “drive picks” icon 960 in FIG. 9, in conjunction with a game situation of an impending kickoff and subsequent kickoff return opportunity.

Graphical user interface 1100 comprises a touch back icon 1110. Selection of touch back icon 1110 indicates a user wager that the result of the upcoming kickoff will be a touch back. Touch back icon 1110 comprises a likelihood factor display 1115. Likelihood factor display 1115 displays a multiplication factor of a wager on a micro event. The likelihood factor is inversely correlated with a probability of the particular play, e.g., micro event, happening. In the example of FIG. 11, the micro wager pays 15 times the points (or real money) wagered if the upcoming micro event, e.g., a touch back, occurs as predicted by the player.

Graphical user interface 1100 further comprises a pick amount field 1120 for touch back icon 1110. Pick amount field 1120 allows a user to change an amount of the bet, e.g., that the result of a kickoff will be a touch back. For example, a pick amount may be increased by touching plus button 1122, and decreased by touching minus button 1121. Pick amount field 1120 may also operate as a slider, e.g., moving a finger touching within pick amount field 1120, toward plus button 1122 increases a wager amount, while moving a finger toward minus button 1121 decreases a pick amount.

In addition, graphical user interface 1100 comprises a potential score display 1126. Potential score display 1126 indicates a number of fantasy points, or real currency, depending on the game type, that may be won if the upcoming micro event occurs as predicted by the player. Potential score display 1126 reflects the pick amount displayed in pick amount field 1120 multiplied by the likelihood factor displayed in likelihood factor display 1115.

In addition, graphical user interface 1100 comprises return icon 1130, for wagering that the result of a kickoff will be a return. Associated with return icon 1130 are pick amount buttons, a pick amount display, a likelihood factor display and a potential score display, which operate in a similar manner to those functions and displays associated with touch back icon 1111.

Further, graphical user interface 1100 comprises touchdown (TD) icon 1150, for wagering that the result of a kickoff will be a touchdown. Associated with return icon 1126 are pick amount buttons, a pick amount display, a likelihood factor display and a potential score display, which operate in a similar manner to those functions and displays associated with touch back icon 1110.

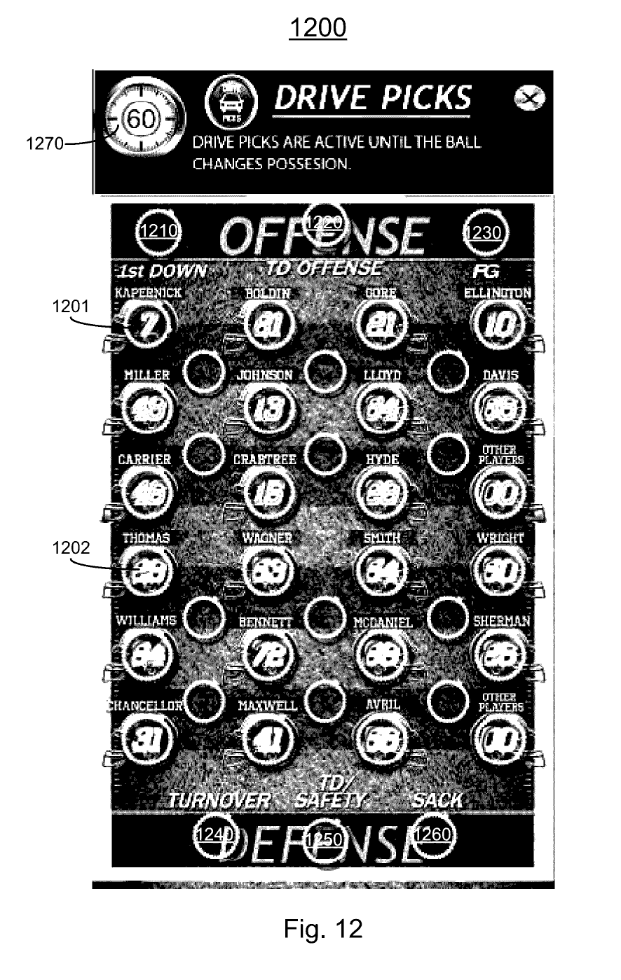

FIG. 12 illustrates an exemplary graphical user interface (GUI) 1200 for selecting details of micro events during a drive, in accordance with embodiments of the present invention. Graphical user interface 1200 may be presented, for example, responsive to indicating a drive picks icon 960 of FIG. 9, in conjunction with a non-kicking game situation. Graphical user interface 1200 enables a player to specify a prediction of the results of a next play, e.g., a next micro event, in which that prediction will last for multiple plays, e.g., the extent of a drive. For example, a player selects a passing play as a prediction for each subsequent play of a drive. In general, the picks made within the drive picks graphical user interface(s) will last until the ball changes possession.

Similar to graphical user interfaces 400 (FIG. 4) and 900 (FIG. 9), approximately the top half of graphical user interface 1200 is for initiation of wagers on micro events related to the offensive team, while approximately the bottom half of display 1200 is for initiation of wagers on micro events related to the defensive team.

Graphical user interface 1200 comprises a plurality of player icons, e.g., player icon 1201, comprising a circle outlining a number. Each player icon represents the player with that number that plays at approximately that position. A player's name may also be associated with a player icon, e.g., “Kapernick.” Selecting a player icon, e.g., by touching the icon, will initiate a different display to select specific details of an upcoming play, e.g., a micro event, involving the player indicted by the player icon. Player icons, e.g., player icon 1202, are presented for defensive players, as well. Selection of a player icon, e.g., player icon 1201, may generally present a graphical user interface for selecting details of a micro event, for example, graphical user interface 500 of FIG. 5.

Graphical user interface 1200 also comprises a plurality of team result icons 1210, 1220, 1230, 1240, 1250 and 1260. Team result icon 1210 represents a prediction that the offense will achieve a first down on the next play. Team result icon 1220 represents a prediction that the offense will score a touch down on the next play. Team result icon 1230 represents a prediction that the offense will score a field goal on the next play.

Team result icon 1240 represents a prediction that the defense will recover a turnover on the next play. Team result icon 1250 represents a prediction that the defense will score a touch down or safety on the next play. Team result icon 1260 represents a prediction that the defense will sack a passer on the next play.

Graphical user interface 1200 further comprises a countdown timer display 1270. Countdown timer display 1270 displays a time remaining to complete selection of a position for a next micro event. Countdown timer display 1270 comprises a numeric display of a time remaining to complete selection of a position for a next micro event, e.g., in seconds.

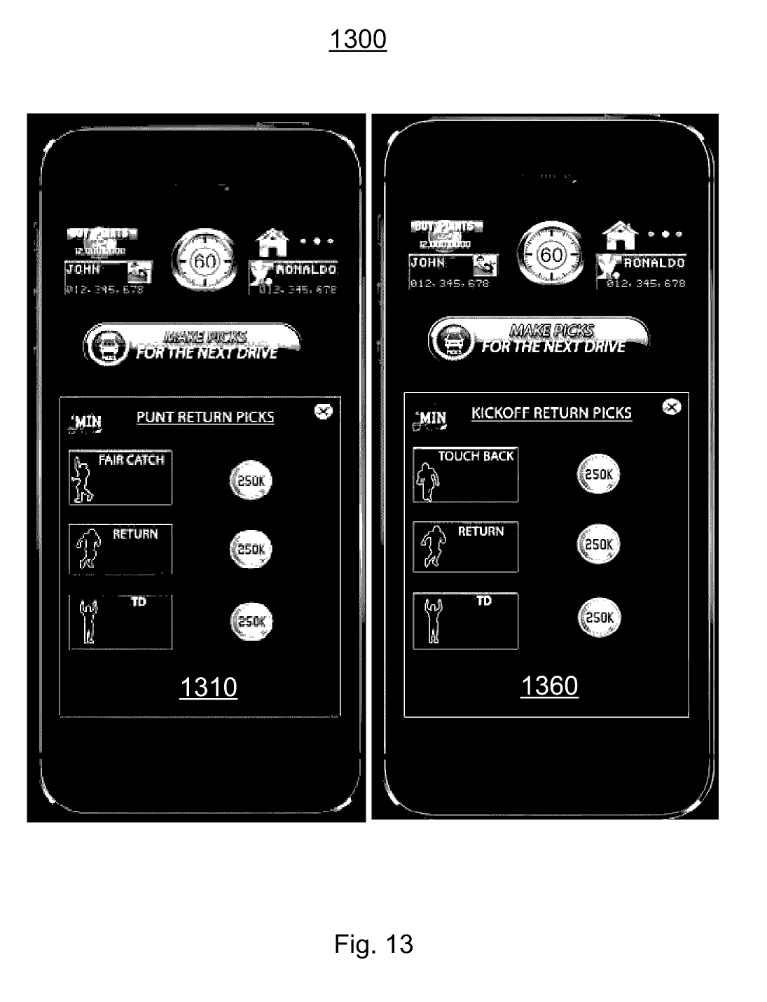

FIG. 13 illustrates two exemplary graphical user interfaces for tracking details of a kick-related drive pick, in accordance with embodiments of the present invention. Graphical user interface 1310 illustrates a graphical user interface for tracking details of punt return drive picks, in accordance with embodiments of the present invention. Graphical user interface 1360 illustrates a graphical user interface for tracking details of kickoff return drive picks, in accordance with embodiments of the present invention. Graphical user interface 1310 may be presented, for example, responsive to a user selecting a “submit picks” icon on a punt return drive picks interface, e.g., as illustrated in graphical user interface 1000 of FIG. 10. Graphical user interface 1360 may be presented, for example, responsive to a user selecting a “submit picks” icon on a kickoff return drive picks interface, e.g., as illustrated in graphical user interface 1100 of FIG. 11.

Graphical user interfaces 1310 and 1360 display an amount wagered for a particular scenario, e.g., a fair catch, touch back, and the like. Typically, only one scenario would be wagered, but that is not required. For example, a “touch down” may also be a “return.” Surrounding a wagered amount with a gold circle or wreath indicates that the wager was successful. In some embodiments, a wager amount may be replaced with “score” amount, for example, a wagered amount multiplied by a likelihood factor.

FIG. 14 illustrates an exemplary graphical user interface (GUI) 1400 for selecting to wager on a running play, in accordance with embodiments of the present invention. Graphical user interface 1400 may be presented, for example, in response to a user selection of a team run, e.g., by indicating run icon 510 of FIG. 5. Graphical user interface 1400 displays player image icons 1410, 1420, 1430 and 1440 of players most likely to run the ball. Player image icon 1410 corresponds to the quarterback R. Wilson, number 3. Player image icon 1420 corresponds to a running back, M. Lynch, number 24. Player image icon 1430 corresponds to a wide receiver, P. Richardson, number 10. Player image icon 1440 corresponds to a fullback, W. Tukuafu, number 46.

In accordance with embodiments of the present invention, a team run wager may be, or may become, a wager that one of the displayed players, e.g., players represented by player image icons 1410, 1420, 1430 and 1440, will run the ball. It is appreciated that other play attributes, e.g., as indicated in graphical user interface 500 of FIG. 5, may offer additional wagering opportunities to a team run wager.

For example, within graphical user interface 500 of FIG. 5, selecting run icon 510, for a gain of 36-100 yards icon 534, up the middle icon 542 for a touchdown 552, in conjunction with graphical user interface 1400, indicates a wager that the displayed player(s), e.g., R. Wilson, M. Lynch, P. Richardson and/or W. Tukuafu, will run the ball up the middle for at least 36 yards, scoring a touchdown.

Graphical user interface 1400 comprises a likelihood factor display 1445. Likelihood factor display 1445 displays a multiplication factor of a wager on a micro event. The likelihood factor is inversely correlated with a probability of the particular play, e.g., micro event, happening. Graphical user interface 1400 further comprises a pick amount field 1450, minus button 1451, plus button 1452 and potential score display 1460, with similar function to pick amount field 650, minus button 651, plus button 652 and potential score increase display 660 of FIG. 6.

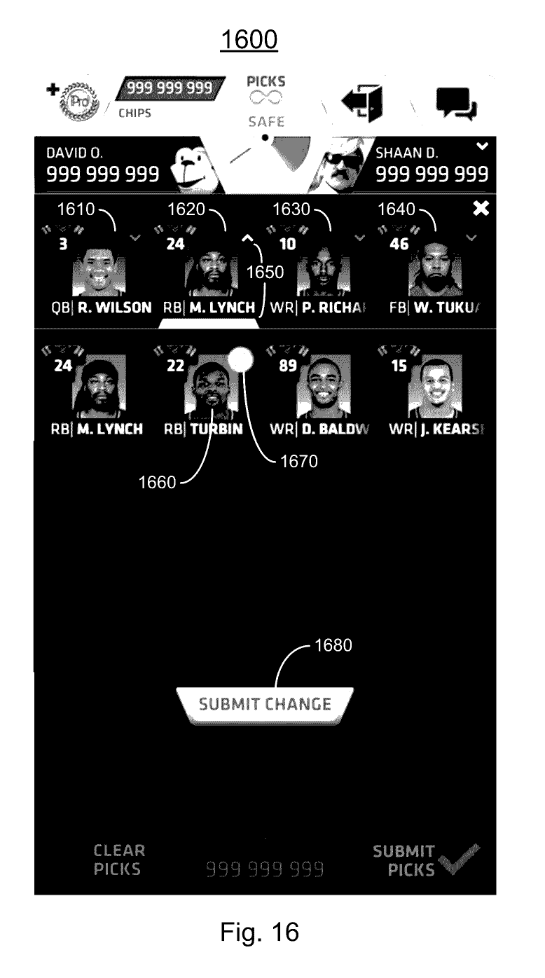

Touching or otherwise indicating a player image icon and/or touching an associated substitution icon, e.g. substitution icon 1421, a “downward arrow,” initiates a player substitution, as further described in FIG. 16, below.

FIG. 15 illustrates an exemplary graphical user interface (GUI) 1500 for selecting to wager on a pass play, in accordance with embodiments of the present invention. Graphical user interface 1500 may be presented, for example, in response to a user selection of a team pass, e.g., by indicating pass icon 520 of FIG. 5. Graphical user interface 1500 displays player image icon 1510 of a player most likely to pass the ball. Player image icon 1510 corresponds to the quarterback R. Wilson, number 3.

Graphical user interface 1500 comprises a pass attempt icon 1520. Graphical user interface 1500 comprises a likelihood factor display 1527. Likelihood factor display 1527 displays a multiplication factor of a wager on a micro event. The likelihood factor is inversely correlated with a probability of the particular play, e.g., micro event, happening. Graphical user interface 1500 further comprises a pick amount field 1525, minus button 1521, plus button 1522 and potential score display 1526, with similar function to pick amount field 650, minus button 651, plus button 652 and potential score display 660 of FIG. 6.

Touching or otherwise indicating a player image icon and/or touching an associated substitution icon, e.g. substitution icon 1511, a “downward arrow,” initiates a player substitution, as further described in FIG. 16, below.

FIG. 16 illustrates an exemplary graphical user interface (GUI) 1600 for substituting players, in accordance with embodiments of the present invention. Graphical user interface 1600 comprises a plurality of player image icons 1610, 1620, 1630 and 1640. Similar to player image icons 1410, 1420, 1430 and 1440 of FIG. 14, player image icons 1610, 1620, 1630 and 1640 represent a player by name, image and/or jersey number. Touching one of player image icons 1610, 1620, 1630 or 1640 indicates a user's selection to replace a player, e.g., in graphical user interface 1400, with another player. For example, a player may be replaced because the player is currently out of the game, another player is having a “better” game, or a player may be replaced because the user wants to wager on an unusual player participating in a play, e.g., a “trick” play. It is appreciated that these examples do not limit the reasons for replacing a player.

In the example of FIG. 16, a user has touched player icon 1620, indicating that player M. Lynch is to be replaced. Such a selection is indicated by indicator(s) 1650, for example, an upwards arrow or “caret,” and/or a bold underline. Further in the example of FIG. 16, a user had touched player icon 1660, indicating that player Turbin is to replace the selected player, e.g., M. Lynch. The selection is confirmed by indicator 1670, e.g., a white checkmark in a green circle. It is appreciated that the selection of a player to be replaced and a replacement player may be made in any order. For example, the replacement player may be selected prior to indicating which player is to be replaced.

The indicated changes, e.g., player to be replaced and replacement player, are finalized by indication, e.g., touching, the submit change icon 1680. In accordance with embodiments of the present invention, after such a player substitution, a subsequent presentation of players, e.g., in graphical user interface 1400 and/or 400, will include the replacement player.

Embodiments in accordance with the present invention provide systems and methods for on-line fantasy wagering. In addition, embodiments in accordance with the present invention provide systems and methods for on-line fantasy wagering that enable a player to select numerous details of a wagers on micro events of a sporting contest. Also, embodiments in accordance with the present invention provide systems and methods for on-line fantasy wagering that utilize effective and intuitive graphical user interfaces. Further, embodiments in accordance with the present invention provide systems and methods for on-line fantasy wagering that are compatible and complementary with existing systems and methods of on-line and/or mobile gaming.

Various embodiments of the invention are thus described. While the present invention has been described in particular embodiments, it should be appreciated that the invention should not be construed as limited by such embodiments, but rather construed according to the below claims.

What is claimed is:

1. A computer-implemented method comprising:
displaying, on a display coupled to the computer, a list of available fantasy game types, wherein the fantasy game types comprise bets on at least two micro events of at least one sporting contest;
responsive to a selected type of fantasy game received by the computer, displaying, on the display, a list of available sporting contests that correspond to the selected type of fantasy game;
responsive to a selected available sporting contest received by the computer, displaying, on the display, a graphical user interface for micro event wagering, wherein the graphical user interface for micro event wagering comprises:
a first portion for selecting to bet on a group of offensive players to run or receive the ball;
a second portion for selecting to bet on a group of defensive players to tackle a ball carrier;
responsive to a selected group of offensive or defensive players received by the computer, displaying, on the display, a graphical user interface for selecting details of a micro event, wherein the graphical user interface for placing a wager on a micro event comprises:
a first element for selecting to bet that the micro event will be a running play;
a second element for selected to bet that the micro event will be a passing play;
a plurality of elements for selecting to bet on yardage to be gained on the micro event;
a plurality of elements for selecting to bet on a direction of the micro event; and
a drive picks icon for selecting to place a recurring bet on a series of micro events during a single drive using a graphical user interface.

2. The computer-implemented method of claim 1 wherein a group size is one single player.

3. The computer-implemented method of claim 2 wherein the one single player is selected via an icon displaying the one single player's uniform number.

4. The computer-implemented method of claim 1 wherein a group size is four players, and the group of players is selected via an icon positioned in-between icons for the four players.

5. The computer-implemented method of claim 1 further comprising:
responsive to a selection of at least one of the elements, displaying, on the display, a graphical user interface for placing a wager on a micro event, wherein the graphical user interface for placing a wager on a micro event comprises:
a display of a type of play selected;
a display of a player selected;
a display of a direction of a play selected;
a display of a payout factor for a micro event wager; and
an element to display and adjust a bet amount for the micro event wager.

6. The computer-implemented method of claim 1 wherein the graphical user interface for use when a duration between plays is decreased comprises:
a first element for selecting a bet amount that a next play will be a run by any player;
a second element for selecting a bet amount that a next play will be a pass to any player;
more than one specific player run elements for selecting a bet amount that a next play will be a run by a specific player, wherein the specific player run elements comprise a display of a specific player's uniform number; and
more than one specific player pass elements for selecting a bet amount that a next play will be a catch by a specific player, wherein the specific player pass elements comprise a display of a specific player's uniform number.

7. The computer-implemented method of claim 1 wherein the graphical user interface for micro event wagering comprises:
a wild card icon for selecting to wager on a play involving any player that is not represented by another displayed player icon.

8. The computer-implemented method of claim 1 wherein the fantasy game types comprise a league, a tournament, and a single game tournament.

9. An article of manufacture including a computer readable medium having instructions stored thereon that, responsive to execution by an electronic system, cause the electronic system to perform operations comprising:
displaying, on a display coupled to the electronic system, a list of available fantasy game types, wherein the fantasy game types comprise bets on at least two micro events of at least one sporting contest;
responsive to a selected type of fantasy game received by the electronic system, displaying, on the display, a list of available sporting contests that correspond to the selected type of fantasy game;
responsive to a selected available sporting contest received by the electronic system, displaying, on the display, a graphical user interface for micro event wagering, wherein the graphical user interface for micro event wagering comprises:
a first portion for selecting to bet on a group of offensive players to run or receive the ball;
a second portion for selecting to bet on a group of defensive players to tackle a ball carrier;
responsive to a selected group of offensive or defensive players received by the electronic system, displaying, on the display, a graphical user interface for selecting details of a micro event, wherein the graphical user interface for placing a wager on a micro event comprises:
a first element for selecting to bet that the micro event will be a running play;
a second element for selected to bet that the micro event will be a passing play;
a plurality of elements for selecting to bet on yardage to be gained on the micro event;
a plurality of elements for selecting to bet on a direction of the micro event; and
a drive picks icon for selecting to place a recurring bet on a series of micro events during a single drive using a graphical user interface.

10. The article of manufacture of claim 9 wherein a group size is one single player.

11. The article of manufacture of claim 10 wherein the one single player is selected via an icon displaying the one single player's uniform number.

12. The article of manufacture of claim 9 wherein a group size is four players, and the group of players is selected via an icon positioned in-between icons for the four players.

13. The article of manufacture of claim 9 wherein the operations further comprise:
responsive to a selection of at least one of the elements, displaying, on the display, a graphical user interface for placing a wager on a micro event, wherein the graphical user interface for placing a wager on a micro event comprises:
a display of a type of play selected;
a display of a player selected;
a display of a direction of a play selected;
a display of a payout factor for a micro event wager; and
an element to display and adjust a bet amount for the micro event wager.

14. The article of manufacture of claim 9 wherein the fantasy game types comprise a league, a tournament, and a single game tournament.

15. An electronic system comprising:
one or more processors coupled to a bus;
a memory coupled to the one or more processors, wherein the memory comprises a gaming application;
a position determining system coupled to the bus operable to determine a geolocation of the electronic system;
a graphical user interface coupled to the bus;
wherein the electronic system is configured to:
display, on a display coupled to the electronic system, a list of available fantasy game types, wherein the fantasy game types comprise bets on at least two micro events of at least one sporting contest;
responsive to a selected type of fantasy game received by the electronic system, display, on the display, a list of available sporting contests that correspond to the selected type of fantasy game;
responsive to a selected available sporting contest received by the electronic system, display, on the display, a graphical user interface for micro event wagering, wherein the graphical user interface for micro event wagering comprises:
a first portion for selecting to bet on a group of offensive players to run or receive the ball;
a second portion for selecting to bet on a group of defensive players to tackle a ball carrier;
responsive to a selected group of offensive or defensive players received by the electronic system, display, on the display, a graphical user interface for selecting details of a micro event, wherein the graphical user interface for placing a wager on a micro event comprises:
a first element for selecting to bet that the micro event will be a running play;
a second element for selected to bet that the micro event will be a passing play;
a plurality of elements for selecting to bet on yardage to be gained on the micro event;
a plurality of elements for selecting to bet on a direction of the micro event; and
a drive picks icon for selecting to place a recurring bet on a series of micro events during a single drive using a graphical user interface.

16. The electronic system of claim 15 wherein the electronic system is a battery-powered mobile system.

17. The electronic system of claim 15 wherein the group of offensive players represents at least one player identified by an icon comprising a uniform number of the player.

18. The electronic system of claim 15 wherein the graphical user interface for use when a duration between plays is decreased comprises:
a first element for selecting a bet amount that a next play will be a run by any player;
a second element for selecting a bet amount that a next play will be a pass to any player;
more than one specific player run elements for selecting a bet amount that a next play will be a run by a specific player, wherein the specific player run elements comprise a display of a specific player's uniform number; and
more than one specific player pass elements for selecting a bet amount that a next play will be a catch by a specific player, wherein the specific player pass elements comprise a display of a specific player's uniform number.

19. The electronic system of claim 15 wherein the graphical user interface for micro event wagering comprises:
a wild card icon for selecting to wager on a play involving any player that is not represented by another displayed player icon.

20. The electronic system of claim 15 wherein the fantasy game types comprise a league, a tournament, and a single game tournament.

21. A computer-implemented method comprising:
displaying, on a display coupled to the computer, a list of available fantasy game types, wherein the fantasy game types comprise bets on at least two micro events of at least one sporting contest;
responsive to a selected type of fantasy game received by the computer, displaying, on the display, a list of available sporting contests that correspond to the selected type of fantasy game; and
responsive to a selected available sporting contest received by the computer, displaying, on the display, a graphical user interface for micro event wagering.

22. The computer-implemented method of claim 21 wherein the graphical user interface for micro event wagering comprises:
a graphical user interface for selecting to bet on a group of offensive players to run or receive the ball.

23. The computer-implemented method of claim 21 wherein the graphical user interface for micro event wagering comprises:
a graphical user interface for selecting to bet on a group of defensive players to tackle a ball carrier.

24. The computer-implemented method of claim 21 wherein the graphical user interface for micro event wagering comprises:
an element for selecting to bet that a micro event will be a running play.

25. The computer-implemented method of claim 21 wherein the graphical user interface for micro event wagering comprises:
an element for selecting to bet that a micro event will be a passing play.

26. The computer-implemented method of claim 21 wherein the graphical user interface for micro event wagering comprises:
a plurality of elements for selecting to bet on yardage to be gained on a micro event.

27. The computer-implemented method of claim 21 wherein the graphical user interface for micro event wagering comprises:
a drive picks icon for selecting to place a recurring bet on a series of micro events during a single drive using a graphical user interface.
